(19) United States
(12) Patent Application Publication
(10) Pub. No.: US 2005/0150868 A1
(43) Pub. Date: Jul. 14, 2005

(54) Electrical switching device with a cooling device

(75) Inventor: Andrzej Nowakowski, Berlin (DE)

Correspondence Address: MORRISON & FOERSTER LLP, 1650 TYSONS BOULEVARD, SUITE 300, MCLEAN, VA, 22102, US

(73) Assignee: SIEMENS AKTIENGESELLSCHAFT, MUNCHEN (DE)

(21) Appl. No.: 10/513,517

(22) PCT Filed: Apr. 10, 2003
(86) PCT No.: PCT/DE03/01260

(30) Foreign Application Priority Data
May 8, 2002 (DE) 102 21 576.6

(51) Int. Cl. H01H 33/88

(52) U.S. Cl. 218/57

(57) ABSTRACT

In order to control the cooling power of a cooling device in an electric switching device (1), through-openings (14a, b, c) can be closed by means of a holding fitting (16). The holding fitting (16) fixes the cooling device in an at least partial manner.

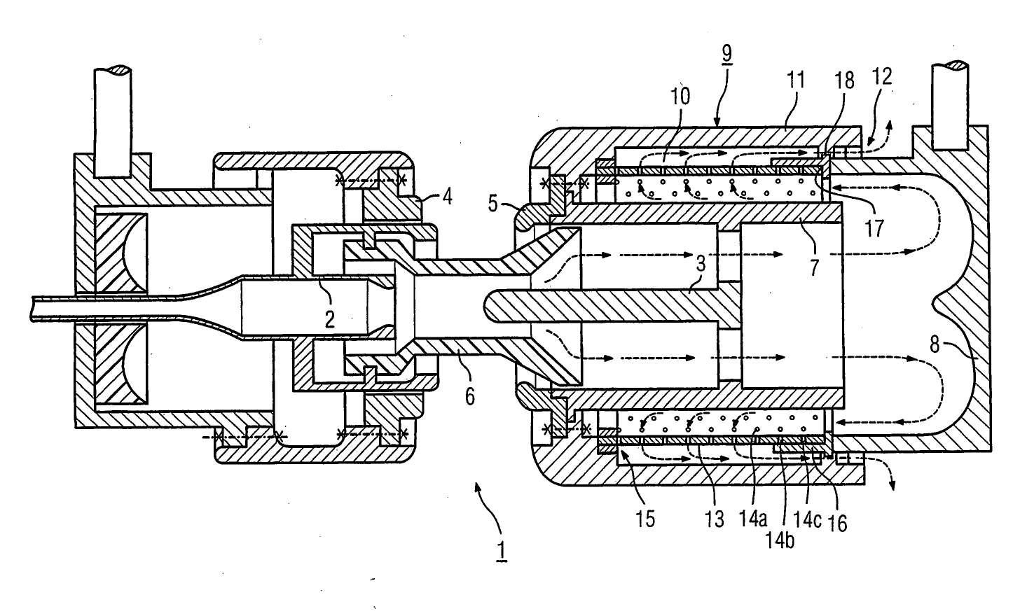

The invention relates to an electrical switching device which produces a quenching gas flow in the course of a disconnection movement, having a solid wall, which has aperture openings for the quenching gas flow, of a cooling device.

An electrical switching device such as this is known, by way of example, from U.S. Pat. No. 4,328,403. The electrical switching device there has a switching gap in which quenching gas is generated by an arc. This quenching gas flows through a channel into a cooling device, which is in the form of a cooling tube. This cooling tube has a solid wall, in which two or more aperture openings are incorporated, for the quenching gas flow to flow through. In order to improve the cooling effect of the cooling tube, the cooling device also has a mesh cooler, which is arranged in the interior of the isolating tube and partially covers the aperture openings.

The cooling effect of a cooling tube such as this is dependent on the number and on the cross section of the aperture openings which are introduced into the solid wall. Depending on the desired cooling effect, it is therefore necessary to introduce a different number of aperture openings into the cooling tube. The cooling power to be provided by the cooling device is governed essentially by the design of the electrical switching device. Changes to the design of the electrical switching device therefore necessarily result in adaptations to the cooling power of the cooling device. This relates in particular to the nature and number as well as the arrangement of the aperture openings.

The present invention is based on the object of designing the cooling device, which has a solid wall, of an electrical switching device so as to make it easier to adapt the cooling power of the cooling device.

In the case of an electrical switching device having a cooling device of the type mentioned initially, the object is achieved according to the invention in that at least one of the aperture openings can be closed by means of a fitting which is connected to the cooling device.

At least one of the aperture openings can be closed in order to control the cooling power of the cooling devices. This makes it possible to use a standard body with aperture openings arranged in a standardized form and to adapt this depending on the design characteristics of the electrical switching device so as to make it possible to achieve a desired cooling behaviur. The combination of the closing effect with a suitable fitting makes it possible not only to grip the solid wall but also to close openings in the solid wall by means of the fitting. The detachable connection of the cooling device and fitting results in advantages relating to the installation of the cooling device in the electrical switching device. Furthermore, different cooling devices with different cooling powers can be assembled in advance using a small number of basic elements. There is therefore no need to stock wide ranges of cooling devices, which would be costly

One advantageous refinement can furthermore provide for the fitting to at least partially fix the cooling device.

A refinement such as this means that there is no need for additional holding devices for fixing the cooling devices. This reduces the number of components required.

It is advantageously possible to provide for the fitting to additionally extend beyond the area which is required for fixing of the cooling device, in order to close at least one of the aperture openings.

An additional extension of the fitting makes it possible to close a greater number of aperture openings in a simple manner. Since the fitting now extends beyond the area which is required for fixing of the cooling devices and is used only to cover and to close the aperture openings, material-saving designs can be used there, since these areas do not need to apply any forces for fixing of the cooling device. The fitting is therefore only slightly heavier, despite the additional closure task.

Furthermore, it is advantageously possible to provide for the solid wall to be tubular.

A tubular wall represents a dielectrically advantageous geometry, on which aperture openings can be arranged over a large area. A high cooling power can thus be achieved with a relatively small physical volume.

A further advantageous refinement provides for the fitting to be arranged on the outside of the tubular solid wall.

If the fitting is arranged on the outside, the internal area of the tubular solid wall remains free of additional installed items. The flow of the quenching gas on the inside of the tubular wall is thus not impeded. Furthermore, the fitting can be mounted on the outside of the tubular solid wall in a simple manner.

It is advantageously possible to provide for the fitting to completely surround the tubular solid wall at one end.

The fitting closes the tubular wall at one end and holds the wall without having to enlarge its circumference to a major extent. The tubular wall can thus be installed and positioned easily in small-volume electrical switching devices. The fact that it is completely surrounded also results in the solid wall being mechanically held well in the fitting. Holding forces which occur are thus distributed over a large area.

In addition to the refinement variants already described, it is also possible to provide for the fitting to form an end socket for the tubular solid wall in the form of a tubular connecting stub, and for the fitting to extend further towards a central section of the tubular solid wall than is necessary for the mechanical holding function.

A tubular connecting stub forms a particularly advantageous refinement variant for the fitting. Tubular connecting stubs can be manufactured, and can be connected to the tubular solid wall, particularly easily.

It is also advantageously possible to provide for the solid wall which has aperture openings to be formed by a perforated plate.

A perforated plate can be produced in a particularly advantageous manner. When a tubular solid wall is used, a tube can easily be produced from the perforated plate. With a suitable refinement of the fitting, it is possible in this case to design the tube such that the perforated plate is formed such that it overlaps in the area of the tube seam, and is held in the tubular shape by the fitting. There is therefore no need for the perforated plate to hold itself in a tubular form, for example by means of welds.

In the following text, the invention will be described in more detail with reference to an exemplary embodiment, and be illustrated in a drawing, in which:

The FIGURE shows the schematic design of an electrical switching device with a cooling device.

The FIGURE shows an electrical switching device 1, to be precise a high-voltage circuit breaker, illustrated schematically. The electrical switching device 1 is arranged within an enclosure, which is filled with an isolating gas but is not illustrated in the FIGURE. The electrical switching device 1 has a moving arc contact piece 2 and a stationary arc contact piece 3. A moving rated current contact piece 4 as well as a stationary arc contact piece 5 are arranged coaxially with respect to the arc contact piece 2 and the stationary contact piece 3 opposite it. During a switching process, an arc occurs on the arc contact pieces 2 and 3. This arc results in a quenching gas being generated in the area of the dielectric nozzle 6 which surrounds the two arc contact pieces 2, 3. Parts of this quenching gas flows out of the dielectric nozzle 6 in the direction of the stationary arc contact piece 3. The stationary arc contact piece 3 is surrounded by a tubular channel 7. First of all, the quenching gas flows in the interior of the tubular channel 7 away from the switching gap that is formed by the two arc contact pieces 2, 3, and is passed to a first flow deflection device 8. The first flow deflection device 8 passes the quenching gas flow to the outside of the tubular channel 7. The first flow deflection device 8 is part of a mounting enclosure 9. The mounting enclosure 9 has a radial opening 10. The radial opening 10 is designed to be circumferential, in an annular shape. The radial opening 10 is covered by means of a second tubular deflection device 11. An outlet flow opening 12, through which the quenching gas can emerge, is formed between the second deflection device 11 and the first deflection device 8.

A tubular solid wall 13 of a cooling device is arranged in the flow path of the quenching gas in the area of the radial opening 10. The tubular solid wall 13 has a large number of aperture openings 14a, b, c. At a first end, the tubular solid wall 13 is mounted in an annular groove 15. A tubular connecting stub 16 is arranged at the second end of the tubular solid wall 13. The tubular connecting stub 16 acts as a fitting and completely surrounds the circumference of the tubular solid wall 13. The tubular connecting stub 16 has a stop 17 which points radially inwards and limits the extent to which the tubular connecting stub 16 is pushed onto the tubular solid wall 13. At the same time, the stop 17 is used as a stop for the flow deflection device 8, which pushes the tubular connecting stub 16 and the tubular solid wall 13 into the stationary annular groove 15. Furthermore, a circumferential collar 18 is formed radially on the outside of the tubular connecting stub 16, and engages in a groove which is located in the deflection device 11. This prevents axial displacement of the tubular connecting stub 16. In this case, the tubular connecting stub 16 extends further in the direction of the center of the tubular solid wall 13 than is necessary for holding the tubular solid wall 13. The cover which is required for holding purposes can be seen in the FIGURE, by way of example, from the depth of the annular groove 15. The extension in the direction of the center of the tubular solid wall 13 closes an aperture opening 14c.

The number of aperture openings which can be closed can be varied by replacing the tubular connecting stub 16 by another tubular connecting stub with a larger/smaller tubular connecting stub length. This allows the cooling power of the cooling device to be varied, and the flow of the quenching gas to be controlled.

The tubular solid wall 13 which is illustrated in the FIGURE may advantageously be formed from a perforated plate. In this case, the perforated plate can be bent to a tubular shape, with the ends of the perforated plate overlapping. The tubular solid wall 13 can be inserted elastically into the annular groove 15 and into the tubular connecting stub 16, in a self-retaining manner, with a slightly greater choice of the diameter of the tubular solid wall 13 with respect to the diameter of the annular groove 15 and with respect to the diameter of the tubular connecting stub 16.

1. An electrical switching device (1) which produces a quenching gas flow in the course of a disconnection movement, having a solid wall (13), which has aperture openings (14a, b, c) for the quenching gas flow, of a cooling device,
characterized in that
at least one of the aperture openings (14c) can be closed by means of a fitting (16) which is connected to the cooling device.

2. The electrical switching device (1) as claimed in claim 1,
characterized in that
the fitting (16) at least partial fixes the cooling device.

3. The electrical switching device (1) as claimed in claim 2,
characterized in that
the fitting (16) additionally extends beyond the area which is required for fixing of the cooling device, in order to close at least one of the aperture openings (14c).

4. The electrical switching device (1) as claimed in claim 1,
characterized in that
the solid wall (13) is tubular.

5. The electrical switching device (1) as claimed in claim 4,
characterized in that
the fitting (16) is arranged on the outside of the tubular solid wall (13).

6. The electrical switching device (1) as claimed in claim 4,
characterized in that
the fitting (16) completely surrounds the tubular solid wall (13) at one end.

7. The electrical switching device (1) as claimed in claim 6,
characterized in that the fitting (16) forms an end socket for the tubular solid wall (13) in the form of a tubular connecting stub, and in that the fitting (16) extends further towards a central section of the tubular solid wall (13) than is necessary for the mechanical holding function.

8. The electrical switching device (1) as claimed in claim 1,
characterized in that
the solid wall (13) which has aperture openings (14a, b, c) is formed by a perforated plate.
